(19) United States
(12) Patent Application Publication
(10) Pub. No.: US 2008/0130121 A1
(43) Pub. Date: Jun. 5, 2008

(54) FILM FOR DISPLAY DEVICE, FILTER INCLUDING FILM AND DISPLAY DEVICE INCLUDING FILTER

(76) Inventors: Kangyoon Kim, Cheongju-si (KR); Ji-Hoon Sohn, Anyang-si (KR); Hongrae Cha, Seoul (KR); Seoungwon Lee, Daejeon (KR); Tae Hoon Park, Seoul (KR); Woonrae Cho, Gunpo-si (KR); Jin-Hun Hoon, Suwon-si (KR); Edhunng Cho, Seoul (KR)

Correspondence Address: BIRCH STEWART KOLASCH & BIRCH, PO BOX 747, FALLS CHURCH, VA, 22040-0747, US

(21) Appl. No.: 11/846,313

(22) Filed: Aug. 28, 2007

(30) Foreign Application Priority Data
Dec. 5, 2006 (KR) 10-2006-0122422
Jan. 12, 2007 (KR) 10-2007-0003659

(51) Int. Cl. G02B 27/00

(52) U.S. Cl. 359/601; 359/613

(57) ABSTRACT

A film for display device, a filter for display device including the film, and a display device including the filter are disclosed. The film for display device includes a plurality of first portions positioned to be spaced with a predetermined distance therebetween, and a plurality of second portions transmitting light. Each second portion is positioned between the first portions. A refractive index of the first portion is larger than a refractive index of the second portion.

This application claims the benefit of Korea Patent Application Nos. 10-2006-0122422 and 10-2007-0003659 filed in Korea on Dec. 5, 2006 and Jan. 12, 2007, which are incorporated herein by reference for all purposes as if fully set forth herein.

### BACKGROUND

1. Field

This document relates to a display device, and more particularly, to a film for display device, a filter for display device including the film, and a display device including the filter.

2. Description of the Background Art

A plasma display device is a kind of a flat panel display device. The plasma display device displays an image or information using a light emission phenomenon generated by a plasma discharge. The plasma display device is classified into an AC type plasma display device and a DC type plasma display device.

The plasma display device includes a plasma display panel displaying an image and a filter for display device positioned in front of the plasma display panel.

The plasma display panel has the structure in which barrier ribs formed between a front panel and a rear panel form unit discharge cell or discharge cells. Each discharge cell is filled with an inert gas containing a main discharge gas such as neon (Ne), helium (He) or a mixture of Ne and He, and a small amount of xenon (Xe). The three discharge cells form one pixel. For example, a red (R) discharge cell, a green (G) discharge cell and a blue (B) discharge cell form one pixel.

When the plasma display panel is discharged by the application of a high frequency voltage to the unit discharge cell, the inert gas generates vacuum ultraviolet rays, which thereby cause phosphors formed between the barrier ribs to emit light, thus displaying an image.

The filter for display device may be positioned in front of various display panels in addition to the plasma display panel to improve the image quality and driving characteristics of display devices. A function and a structure of the filter for display device have been continuously studied.

### SUMMARY

Accordingly, exemplary embodiments provide a film for display device, a filter for display device including the film, and a display device including the filter capable of improving a contrast ratio.

Exemplary embodiments also provide a film for display device, a filter for display device including the film, and a display device including the filter capable of preventing a ghost phenomenon of an image.

In one aspect, a film for display device comprises a plurality of first portions positioned to be spaced with a predetermined distance therebetween, and a plurality of second portions that transmit light, each second portion being positioned between the first portions, wherein a refractive index of the first portion is larger than a refractive index of the second portion.

Implementations may include one or more of the following features. For example, the first portion may have a cross section whose a width of one edge is different from a width of the other edge.

A color of the first portion may be darker than a color of the second portion.

The predetermined distances between the first portions may be different from each other, or equal to each other.

The refractive index of the first portion may be equal to or less than 1.3 times the refractive index of the second portion.

The first portion may comprise a black pigment.

The first portion may comprise a photosensitive resin and a black pigment.

In another aspect, a filter for display device comprises a film for display device that includes a plurality of first portions positioned to be spaced with a predetermined distance therebetween and a plurality of second portions transmitting light, each second portion being positioned between the first portions, wherein a refractive index of the first portion is larger than a refractive index of the second portion, and at least one of a near-infrared ray shielding film, a color correction film, an anti-reflection film, or an electromagnetic interference (EMI) shielding film.

In still another aspect, a display device comprises a display panel, and a filter for display device that is positioned in front of the display panel and includes a plurality of first portions positioned to be spaced with a predetermined distance therebetween and a plurality of second portions transmitting light, each second portion being positioned between the first portions, wherein a refractive index of the first portion is larger than a refractive index of the second portion.

Implementations may include one or more of the following features. For example, the first portion may have a larger cross-sectional area as it goes toward the display panel.

The display panel may be one of a liquid crystal display panel and a plasma display panel.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIG. 1 illustrates a film for display device according to an exemplary embodiment;

FIG. 2 illustrates a cross section of the film for display device of FIG. 1;

FIGS. 3a to 3c illustrate an arrangement structure of a non-transmissive portion of a film for display device according to an exemplary embodiment;

FIGS. 4a and 4b illustrate a structure of a filter for display device according to an exemplary embodiment;

FIG. 5 illustrates a display device including a filter for display device of FIGS. 4a and 4b according to an exemplary embodiment;

FIG. 6 schematically illustrates a cross section of the display device of FIG. 5;

FIGS. 7a and 7b are views for explaining a ghost phenomenon generated when an image is displayed; and

FIG. 8 is a graph of an emission efficiency of image light depending on a refractive index of a film for display device.

### DETAILED DESCRIPTION OF EMBODIMENTS

Reference will now be made in detail embodiments of the invention examples of which are illustrated in the accompanying drawings.

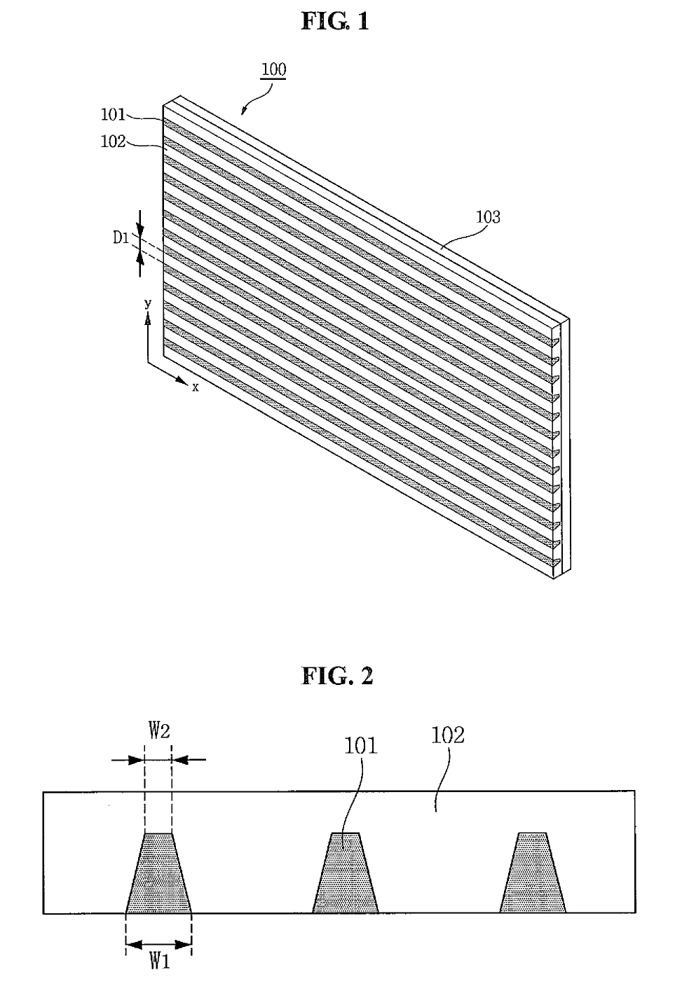

FIG. 1 illustrates a film for display device according to an exemplary embodiment.

As illustrated in FIG. 1, the film for display device includes a transmissive portion 102 transmitting light (hereinafter referred to as a second portion), a non-transmissive portion 101 (hereinafter referred to as a first portion), and a base film 103 supporting the transmissive portion 102 and the non-transmissive portion 101. The non-transmissive portions 101 are positioned to be spaced with a predetermined distance therebetween inside the transmissive portion 102.

The first portion 101 includes at least one of a black pigment and a photosensitive resin capable of absorbing light. The photosensitive resin may be formed by mixing carbon black with thermosetting resin, photo-crosslinked resin or ultraviolet (UV) curable polymer.

Predetermined distances D1 between the first portions 101 may be equal to one another. At least one of the predetermined distances D1 may be different from the other distances D1. This compensates a difference between contrast ratios of an image generated at a predetermined position of a display panel due to structural characteristics of the display panel.

The second portion 102 includes a transparent resin such as UV-curable polymer capable of transmitting light. UV-curable polymer may include polyester, urethane, epoxy, or oligomer containing silicon and acryl functionalities, or monomer.

The first portion 101 may include a material darker than the second portion 102 to absorb light. Hence, when an image is displayed, a contrast characteristic can be improved. In particular, a refractive index of the first portion 101 is larger than a refractive index of the second portion 102. When the refractive index of the first portion 101 is larger than the refractive index of the second portion 102, a ghost phenomenon generated during the display of an image is prevented and the image quality is improved.

The base film 103 is formed of a transparent resin. Examples of the transparent resin include polyethyleneterephthalate (PET), polycarbonates (PC), polyvinyl chloride (PVC).

FIG. 2 illustrates a cross section of the film for display device of FIG. 1.

As illustrated in FIG. 2, the first portion 101 has a cross section whose a width w1 of one edge is different from a width w2 of the other edge. In other words, the first portion 101 has a trapezoid-shaped cross section having a slope between one edge and the other edge of the first portion 101.

Although it is not shown in the drawings, the first portion 101 may have one of a triangular shape, a tetragonal shape, a circle of curvature shape, and a wedged shape. The above-described cross section shapes of the first portion 101 facilitate a process for fabricating the film for display device.

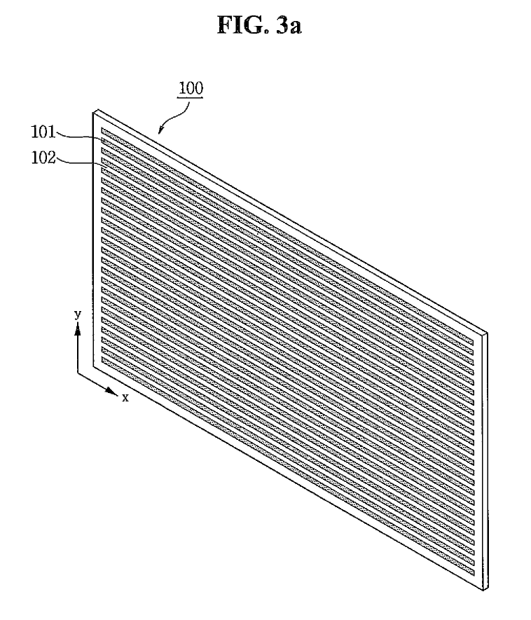

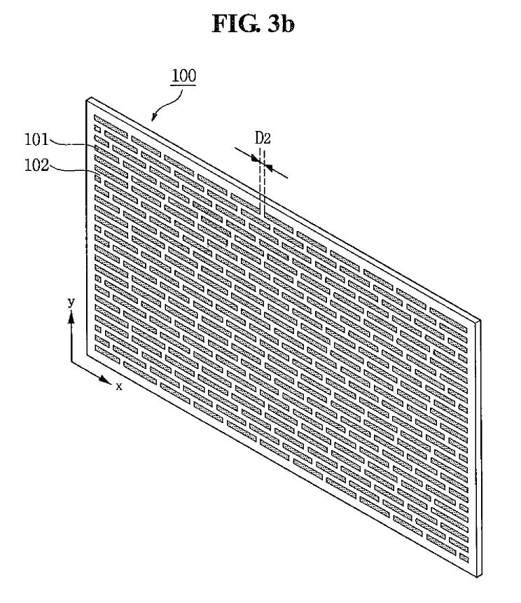

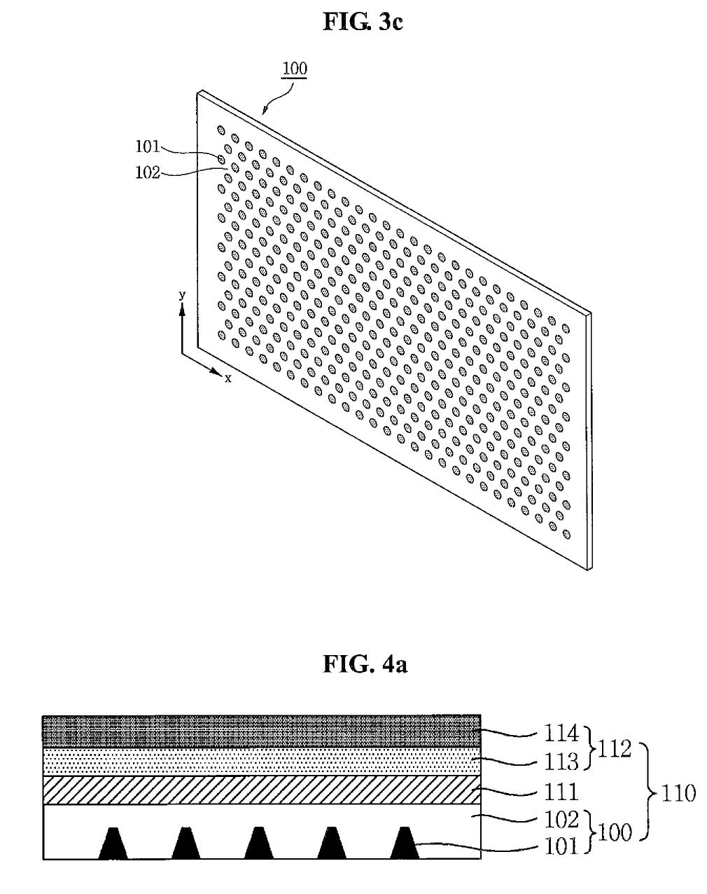

FIGS. 3a to 3c illustrate an arrangement structure of a non-transmissive portion of a film for display device according to an exemplary embodiment.

In a film 100 for display device of FIG. 3a, the plurality of first portions 101 (the non-transmissive portions) are arranged in a stripe form in an X-axis direction. An area except the first portion 101 is the second portion 102 (the transmissive portion). In this case, the X-axis direction is a horizontal direction of a display panel displaying an image.

In a film 100 for display device of FIG. 3b, the plurality of rectangular-shaped first portions 101 are arranged in an X-axis direction. In this case, distances D2 between the rectangular-shaped first portions 101 in the X-axis direction may be equal to one another. At least one of the distances D2 between the rectangular-shaped first portions 101 may be different from the other distances D2. The arrangement structure of the first portions 101 compensates a difference between contrast ratios of an image generated at a predetermined position of a display panel.

In a film 100 for display device of FIG. 3c, the plurality of first portions 101 each having a circle-shaped cross section are arranged.

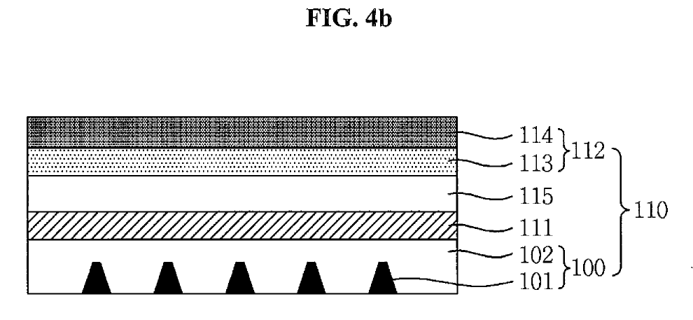

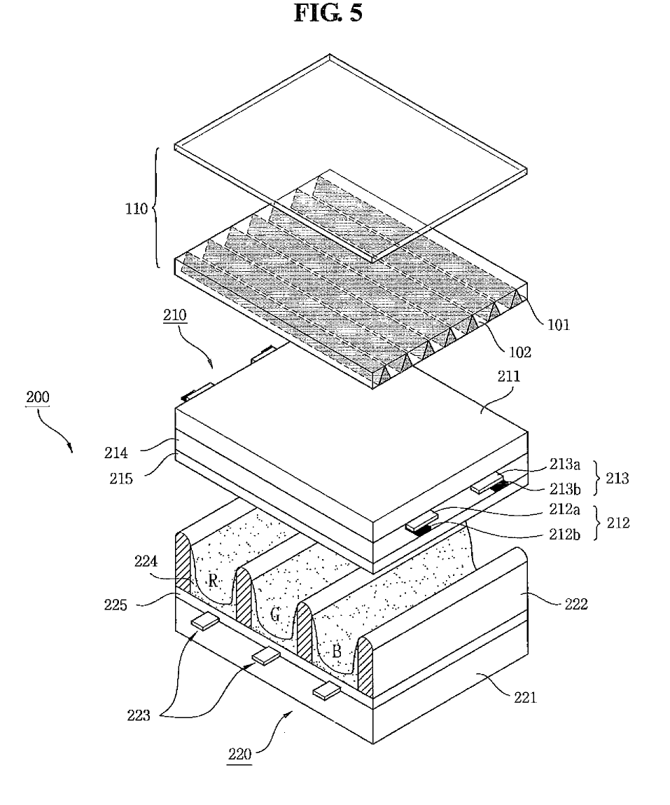

FIGS. 4a and 4b illustrate a structure of a filter for display device according to an exemplary embodiment.

A filter 110 for display device is roughly classified into a film filter illustrated in FIG. 4a and a glass filter illustrated in FIG. 4b.

First, as illustrated in FIG. 4a, a film filter 110 includes a film 100 illustrated in FIG. 1 for compensating brightness, and a functional film. The functional film includes at least one of an electromagnetic interference (EMI) shielding film 111 and a color correction film 112. The color correction film 112 includes at least one of a near-infrared ray shielding film 113 and an anti-reflection film 114. The plurality of layers constituting the film filter 110 can be stacked regardless of the stacking order. However, the brightness compensation film 100 may use as a base layer, and the functional films may be stacked on the brightness compensation film 100. In this case, the stacking order of the functional films is not limited.

Next, as illustrated in FIG. 4b, a glass filter 110 includes a brightness compensation film 100 illustrated in FIG. 1, a functional film, and a glass 115. An EMI shielding film 111 and the brightness compensation film 100 are positioned under the glass 115, and a color correction film 112 is positioned on the glass 115. The color correction film 112 includes at least one of a near-infrared ray shielding film 113 and an anti-reflection film 114 in the same way as the film filter of FIG. 4a. The plurality of layers constituting the glass filter 110 can be stacked regardless of the stacking order in the same way as the film filter of FIG. 4a. However, the brightness compensation film 100 may use as a base layer, and the functional films may be stacked on the brightness compensation film 100.

FIG. 5 illustrates a display device including a filter for display device of FIGS. 4a and 4b according to an exemplary embodiment.

As illustrated in FIG. 5, a display device includes a display panel 200 and a filter 110 for display device.

The display panel 200 may include a panel of a flat panel display device such as a liquid crystal display (LCD) or a plasma display panel (PDP). For instance, the display panel 200 includes a front panel 210 and a rear panel 220 which are coupled in parallel to oppose to each other at a given distance therebetween. The front panel 210 includes a front substrate 211 which is a display surface displaying an image. The rear panel 220 includes a rear substrate 221 constituting a rear surface. A plurality of scan electrodes 212 and a plurality of sustain electrodes 213 are formed in pairs on the front substrate 211 to form a plurality of maintenance electrode pairs. A plurality of data electrodes 223 are arranged on the rear substrate 221 to intersect the plurality of maintenance electrode pairs.

The scan electrode 212 and the sustain electrode 213 generate a mutual discharge therebetween in one discharge cell and maintain light-emissions of discharge cells. The scan electrode 212 and the sustain electrode 213 each comprise transparent electrodes 212a and 213a made of a transparent ITO material and bus electrodes 212b and 213b made of a metal material. Moreover, the scan electrode 212 and the sustain electrode 213 each may comprise only the transparent electrode or only the bus electrode. The scan electrode 212 and the sustain electrode 213 are covered with one or more upper dielectric layers 214 for limiting a discharge current and providing insulation between the maintenance electrode pairs. A protective layer 215 with a deposit of magnesium oxide (MgO) is formed on an upper surface of the upper dielectric layer 214 to facilitate discharge conditions.

A plurality of stripe-type or well-type barrier ribs 222 are formed in parallel to each other on the rear substrate 221 of the rear panel 220 to form a plurality of discharge spaces, i.e., a plurality of discharge cells. The plurality of data electrodes 223 for performing an address discharge to generate vacuum ultraviolet rays are arranged in parallel to the barrier ribs 222. An upper surface of the rear substrate 221 is coated with red (R), green (G) and blue (B) phosphors 224 for emitting visible light for an image display during the generation of the address discharge. A lower dielectric layer 225 is formed between the data electrodes 223 and the phosphors 224 to protect the data electrodes 223.

The front panel 210 and the rear panel 220 thus formed are coalesced using a sealing process to complete the display panel 200. The drivers (not illustrated) for driving the scan electrode 212, the sustain electrode 213 and the data electrode 223 are attached to the display panel 200.

The filter 110 for display device is positioned in front of the display panel 200, and includes the film 100 illustrated in FIG. 1. The first portion 101 of the film 100 has a larger cross-sectional area as it goes toward the display panel 200.

Because a refractive index of the first portion 101 of the film 100 is larger than a refractive index of the second portion 102 of the film 100, the first portion 101 blocks the reflection of external light and a ghost phenomenon is prevented. Hence, a contrast ratio of the display device is improved.

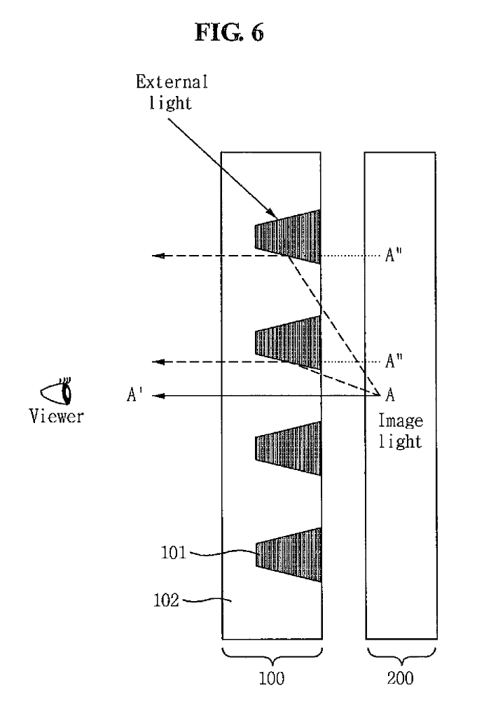

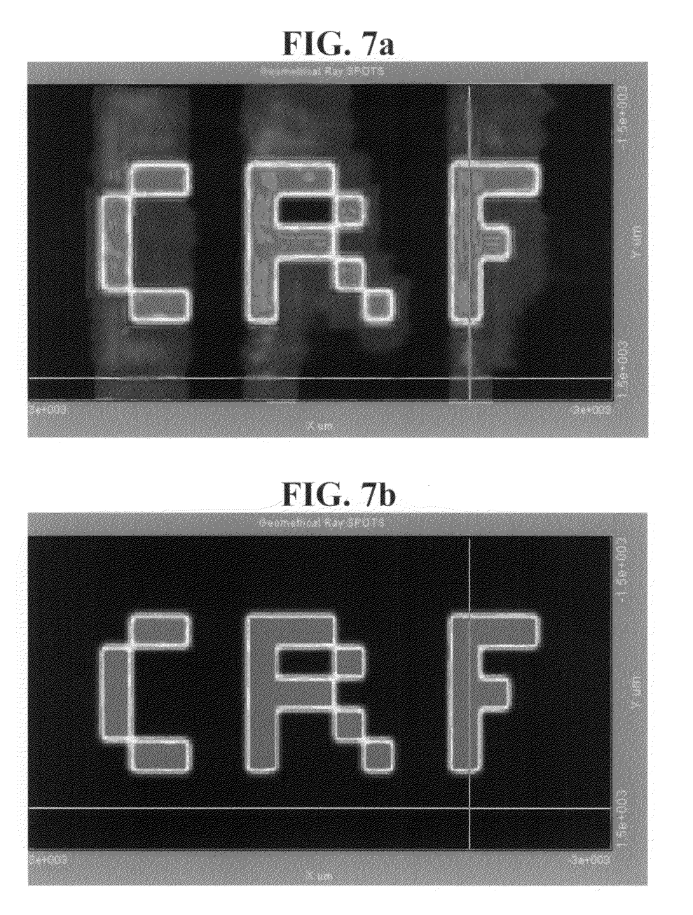

FIG. 6 schematically illustrates a cross section of the display device of FIG. 5. FIGS. 7a and 7b are views for explaining a ghost phenomenon generated when an image is displayed.

Referring to FIG. 6 and FIGS. 7a and 7b, image light emitted from an area A of the display panel 200 is transmitted through the second portion 102, and then a viewer watches the image light through his eye in all area A′. However, when image light emitted from the area A is incident on the first portion 101 through the second portion 102, reflectivity of the image light changes due to a refractive index of the first portion 101 and a refractive index of the second portion 102. In other words, when the refractive index of the second portion 102 is larger than the refractive index of the first portion 101, the image light incident on the first portion 101 through the second portion 102 is totally reflected in the first portion 101. In this case, the viewer recognizes the image light emitted from the area A as image light emitted from an area A″ of the display panel 200. This is a ghost phenomenon in which an image runs on the screen or the image overlaps doubly, as illustrated in FIG. 7a.

However, when the refractive index of the first portion 101 is larger than the refractive index of the second portion 102, image light incident on the first portion 101 through the second portion 102 is not totally reflected in the first portion 101. In other words, while image light incident on the first portion 101 through the second portion 102 is partially reflected in the first portion 101 due to a difference between the refractive index of the first portion 101 and the refractive index of the second portion 102, the image light is not totally reflected in the first portion 101 because total reflection conditions of image light are not satisfied. Accordingly, a ghost phenomenon is prevented and a clear image is displayed on the display panel 200 as illustrated in FIG. 7b.

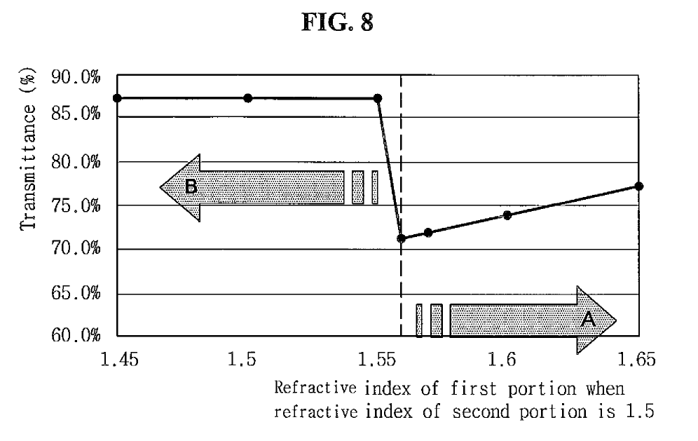

FIG. 8 is a graph of an emission efficiency of image light depending on a refractive index of a film for display device.

As illustrated in FIG. 8, when the refractive index of the second portion 102 is 1.5 and the refractive index of the first portion 101 is smaller than the refractive index of the second portion 102, the image light emitted from the display panel 200 is totally reflected in the first portion 101. Accordingly, transmittance of the display panel 200 increases and then is maintained at a predetermined value (i.e., at 87.0%). As above, when the transmittance of the display panel 200 increases due to the total reflection, the contrast characteristic of the display device is improved. However, this leads to the ghost phenomenon. An arrow B in FIG. 8 indicates a generation direction of total reflection of the image light in the first portion 101.

On the other hand, when the refractive index of the first portion 101 is larger than the refractive index of the second portion 102, image light emitted from the display panel 200 is not totally reflected in the first portion 101, reflectivity of the image light emitted from the display panel 200 increases in the first portion 101 due to a difference between the refractive index of the first portion 101 and the refractive index of the second portion 102, and transmittance of the display panel 200 increases. Accordingly, the contrast characteristic of the display device is improved. However, when the refractive index of the first portion 101 continuously increases as compared with the refractive index of the second portion 102, the reflectivity of the image light increases in the first portion 101. This may lead to the ghost phenomenon.

Accordingly, the refractive index of the first portion 101 is larger than and equal to or less than 1.3 times the refractive index of the second portion 102.

An arrow A in FIG. 8 indicates an increasing direction of reflectivity of the image light in the first portion 101.

As described above, the display device according to the exemplary embodiment improves the contrast characteristic by increasing the emission efficiency of image light of the display panel, and prevents the ghost phenomenon by controlling the refractive index of the film for display device. Accordingly, the image quality of the display device is improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A film for display device comprising:
a plurality of first portions positioned to be spaced with a predetermined distance therebetween; and
a plurality of second portions that transmit light, each second portion being positioned between the first portions,
wherein a refractive index of the first portion is larger than a refractive index of the second portion.

2. The film for display device of claim 1, wherein the first portion has a cross section whose a width of one edge is different from a width of the other edge.

3. The film for display device of claim 1, wherein a color of the first portion is darker than a color of the second portion.

4. The film for display device of claim 1, wherein the predetermined distances between the first portions are different from each other, or are equal to each other.

5. The film for display device of claim 1, wherein a cross section of the first portion has at least one of a triangular shape, a tetragonal shape, a circle of curvature shape, and a wedged shape.

6. The film for display device of claim 1, wherein the refractive index of the first portion is equal to or less than 1.3 times the refractive index of the second portion.

7. The film for display device of claim 1, wherein the first portion comprises a black pigment.

8. The film for display device of claim 1, wherein the first portion comprises a photosensitive resin and a black pigment.

9. A filter for display device comprising:
a film for display device that includes a plurality of first portions positioned to be spaced with a predetermined distance therebetween and a plurality of second portions transmitting light, each second portion being positioned between the first portions, wherein a refractive index of the first portion is larger than a refractive index of the second portion; and
at least one of a near-infrared ray shielding film, a color correction film, an anti-reflection film, or an electromagnetic interference (EMI) shielding film.

10. The filter for display device of claim 9, wherein the first portion has a cross section whose a width of one edge is different from a width of the other edge.

11. The filter for display device of claim 9, wherein the refractive index of the first portion is equal to or less than 1.3 times the refractive index of the second portion.

12. A display device comprising:
a display panel; and
a filter for display device that is positioned in front of the display panel and includes a plurality of first portions positioned to be spaced with a predetermined distance therebetween and a plurality of second portions transmitting light, each second portion being positioned between the first portions, wherein a refractive index of the first portion is larger than a refractive index of the second portion.

13. The display device of claim 12, wherein the first portion has a larger cross-sectional area as it goes toward the display panel.

14. The display device of claim 12, wherein the display panel is one of a liquid crystal display panel and a plasma display panel.

15. The display device of claim 12, wherein the filter for display device comprises at least one of a near-infrared ray shielding film, a color correction film, an anti-reflection film, or an electromagnetic interference (EMI) shielding film.

16. The display device of claim 12, wherein a color of the first portion is darker than a color of the second portion.

17. The display device of claim 12, wherein the predetermined distances between the first portions are different from each other, or are equal to each other.

18. The display device of claim 12, wherein the refractive index of the first portion is equal to or less than 1.3 times the refractive index of the second portion.

19. The display device of claim 12, wherein the first portion comprises a black pigment.

20. The display device of claim 12, wherein the first portion comprises a photosensitive resin and a black pigment.
